(19) United States
(12) Patent Application Publication
(10) Pub. No.: US 2013/0341392 A1
(43) Pub. Date: Dec. 26, 2013

(54) METHOD OF PROVIDING INFORMATION ABOUT A TANGIBLE OBJECT

(71) Applicant: Bryan C. Ahee, Galesburg, IL (US)

(72) Inventor: Bryan C. Ahee, Galesburg, IL (US)

(21) Appl. No.: 13/531,746

(22) Filed: Jun. 25, 2012

(51) Int. Cl. G06F 17/30

(52) U.S. Cl. 235/375

(57) ABSTRACT

A method of providing information about a tangible object that includes providing a tangible object that has a machine readable medium such as a RFID tag. Information can then be inputted into that RFID tag by a handheld device in order to alter the RFID tag such that the tag has additional information contained therein so that another handheld device can be used to scan the information.

### BACKGROUND OF THE INVENTION

This invention relates to a method of providing information about a tangible object. More specifically this invention relates to the utilization of scannable technologies in association with handheld devices to provide information regarding objects.

There are many situations in which information is logged, recorded or desired to be recorded for individuals. As an example companies attempt to gather information regarding vehicles including any accidents a vehicle may have been in, any body work or engine work that may have been done, or the like. Specifically, individuals purchasing a used car do not always see the sellers of used cars as trustworthy individuals and desire to have as much information as possible about the vehicle before purchasing.

In other situations, inspectors will come and inspect certain pieces of food processing equipment to determine the state of the equipment. Other inspectors are utilized in the food industry to inspect kitchens, equipment and the like to ensure that certain locations are always up to code. In these types of situations documentation of inspections is provided and recorded. To that end oftentimes reports are filled out by inspectors and if time permits can be inputted into some sort of computer readable format for recording purposes. However, problems still remain even in the inspection setting in that filling out the paperwork and then taking it to a remote location to input is both time consuming and can provide the potential for error. Specifically a file may not be properly scanned or entered into the records in the computer system or assigned to an incorrect location, food processing unit or other item that are inspected.

Other problems exist in the relaying of information quickly. As an example, when an individual desires to receive a taxi that individual must look up the taxi's phone number or call information to receive the taxicab's phone number and then call in order to request the cab to come pick them up or alternatively wait at a taxi stand in hopes that eventually a cab will come to pick them up. Thus, a need in the art exists in order to enhance communication abilities and information sharing abilities to reduce inefficiencies, wasted time and human error when it comes to recording and processing information.

Thus, a principle object of the present invention is to provide a method of providing information that is efficient.

Yet another object of the present invention is to provide a method of providing information that minimizes the amount of time needed to convey and receive information.

Another object of the present invention is to provide a method of providing information that enhances the amount of information presented regarding different tangible objects.

These and other objects, features, or advantages will become apparent from the specification and claims.

### BRIEF SUMMARY OF THE INVENTION

A method of providing information about a tangible object that includes providing a tangible object that has a machine readable medium associated therewith. Information is then inputted that is related to the tangible object into the machine readable medium by altering the machine readable medium. Then a handheld device is used in order to scan the altered machine readable medium to retrieve the altered information.

### BRIEF DESCRIPTION OF THE DRAWINGS

FIG. 1 is a schematic diagram of an information system; and

FIG. 2 is a schematic diagram of a handheld device.

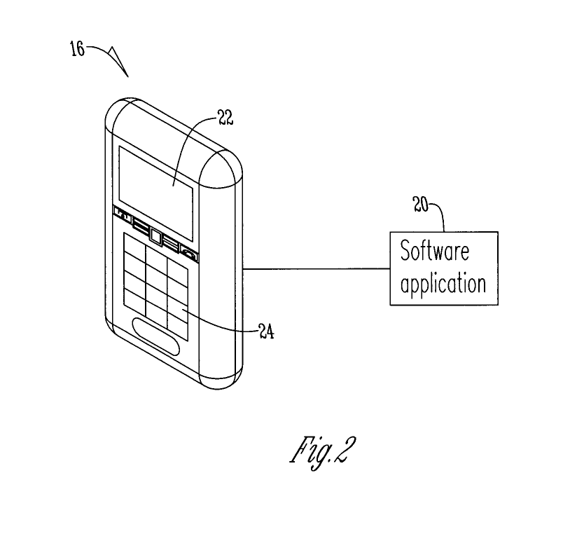

### DETAILED DESCRIPTION OF THE PREFERRED EMBODIMENT

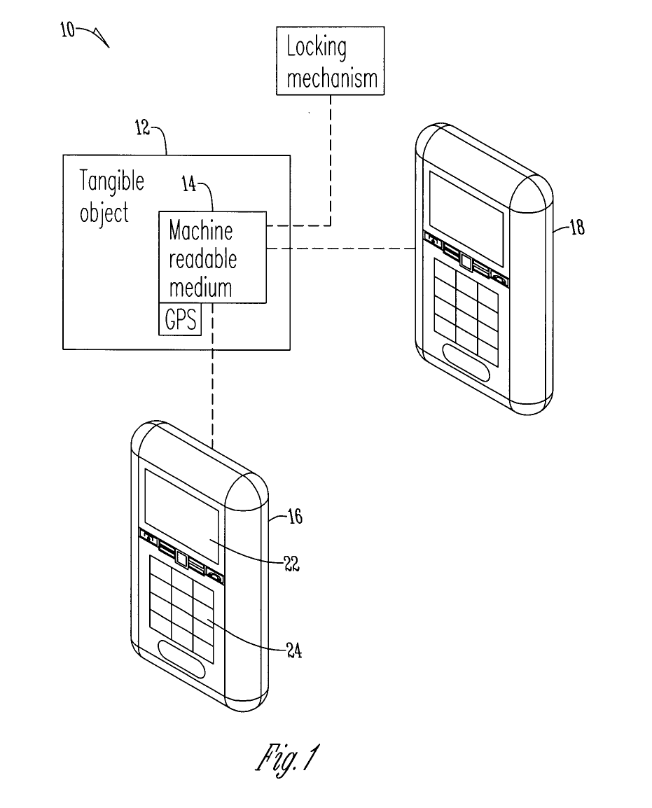

FIG. 1 shows an information system 10 that includes a tangible object 12. The tangible object 12 can be any product or landmark such as a motor vehicle, a food processing machine, an article of clothing, a bracelet, a taxi stand, or the like. The tangible object 12 has a machine readable medium 14 associated therewith where in a preferred embodiment the machine readable medium 14 is printed onto the tangible object 12. Machine readable medium can include but is not limited to RFID (radio frequency identification) tags, barcode, barcode matrix, NFC (near field communication), augmented reality such as holograms, and the like. Specifically, the machine readable medium 14 not only has information encoded or embedded therein that can be read by a first or second handheld device 16 or 18 but additionally the handheld devices 16 or 18 can be utilized to provide information to the machine readable medium 14. The machine readable medium 14 contains code that can be altered by a handheld device 16 or 18 in order to embed additional information within the machine readable medium as desired.

The first and second handheld devices 16 and 18 can include but are not limited to cellular telephones, iPhones®, Smartphones, BlackBerries®, iPads® and other tablet devices or the like that are able to have software applications 20 that allow the first and second handheld devices 16 and 18 to read or scan machine readable medium 14 and input information into such machine readable medium 14. The information can be setup via the Internet and stored at a secure location. Information can be programmed using a laptop or desktop computer. This information can be viewed using a computer. Each of the first and second handheld devices 16 and 18 also have a display 22 and inputs 24 for inputting information that is then transferred into the machine readable medium 14.

In operation an individual having a first handheld device 16 inputs information into the handheld device 16 via the inputs 24 and then inputs this information into a machine readable medium 14 associated with a tangible object 12. The information transmitted is related to the tangible object 12 such that a second handheld device 18 can then scan the altered machine readable medium 14 in order to receive the information inputted.

In a first example, the tangible object 12 is an article of clothing such as a wristband, headband, athletic shorts, a set of weights, treadmill, or other exercise machine or the like that have machine readable medium 14 such as a barcode matrix thereon that contains workout information such as days of the week an individual desires to work out or the routine for a certain day. Thus, an individual ready to work out need only to use a first handheld device 16 in order to scan the machine readable medium 14 so that they can be informed what the workout for that day requires. Then, upon completing a workout that individual can input information using the first handheld device 16 into the machine readable medium 14 such as whether all of the suggested workouts were completed, the amount of time it took to complete workouts, individual's heart rate during a workout, the amount of reps completed and the like. Thus, a log is kept of an individual's process and workout within the machine readable medium 14. At the end of a month or a predetermined time period a handheld device 16 or 18 may be utilized to scan the machine readable medium 14 to see the progress that has been made regarding a workout.

In another embodiment the tangible object 12 is a food processing device that needs to be inspected to ensure compliance with all regulations. These include inspections as required by state, federal and local governments and the like on machines such as restaurant ventilation systems, dishwashers, kitchen sanitation and the like. An inspector may use his first handheld device 16 in order to input information regarding the inspection into the machine readable medium 14. Thus, the processing unit itself has a continuous record of safety checks, repairs and the like with the machine readable medium so that if a different inspector comes to the location and records from a previous inspector have been lost or not communicated, the second inspector's handheld device 18 automatically informs the inspector of the previous inspections without the need to track down lost information.

In yet another embodiment the tangible object can be a vehicle where the machine readable medium 14 is either on the vehicle itself or in paperwork in a glove compartment of the vehicle. Thus, information about the vehicle can be embedded in the machine readable medium 14 when a vehicle goes in for an oil change, maintenance, body work or the like by the mechanic working on the vehicle. Thus as maintenance is done on a vehicle this is constantly updated in the machine readable medium 14 such that when an individual goes to purchase a car they only need to use their handheld device 18 to scan the machine readable medium 14 to have a complete list of the maintenance and history of the vehicle. Therefore, an individual is able to see how well a car was maintained, or if accidents or other issues occurred throughout the life of the vehicle.

In another embodiment the tangible object is a vehicle that is utilized in hauling equipment such as a semi that must undergo inspections at certain check points. Again, instead of providing paperwork as in the food processing application, the information may be inputted from a handheld device 16 into the machine readable medium thus eliminating the need for unnecessary paperwork.

In yet another embodiment the machine readable medium 14 is again on a piece of clothing such as a bracelet that is associated with a hotel or a resort. This bracelet may then be utilized in association with a locking mechanism that scans the bracelet in order to lock and unlock a door to a hotel room.

In yet another embodiment the tangible object may be a commercial product such as ice cream, or a machine that utilizes the machine readable medium in order to input information with a handheld device 16 into the machine readable medium about SOPS, maintenance logs, prints, bill of materials, parts break down, part numbers, manufacturer information, manuals, notes and the like. Again, paperwork is eliminated and the efficiency of the process is improved.

Other similar applications may include utilizing such machine readable medium 14 in association with GPS within clothing to locate missing persons or in association with mass transit units such as taxicab stands such that the medium 14 can be scanned to input information that an individual needs to be picked up at a stand that goes directly to a central communication base for relaying the information to a taxicab driver or other transit vehicle operator.

Thus, provided is a method of providing information about a tangible object that reduces paperwork and the amount of time utilized to convey information providing an efficient process. This method can be used on a variety of tangible objects, provides more information about the tangible objects than that is currently available and provides immediate communication and information processing. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

1. A method of providing information about a tangible object steps comprising:
providing a tangible object having a machine readable medium associated therewith;
inputting information related to the tangible object into the machine readable medium by altering the machine readable medium;
retrieving the information in the altered machine readable medium with a handheld device;
wherein the tangible object is an article of clothing;
wherein the information inputted into the machine readable medium is workout information;
wherein when the machine readable medium is retrieved with the handheld device, a user is provided with requirements for a workout for a day.

2. The method of claim 1 wherein the machine readable medium is printed onto the tangible object.

3. (canceled)

4. A method of providing information about a tangible object steps comprising;
providing a tangible object having a machine readable medium associated therewith;
inputting information related to the tangible object into the machine readable medium by altering the machine readable medium;
retrieving the information in the altered machine readable medium with a handheld device;
wherein the tangible object is food processing equipment and the information inputted into the machine readable medium is related to inspection of the food processing equipment;
wherein when the information is retrieved from the machine readable medium a user is provided with information from previous inspections.

5. A method of providing information about a tangible object steps comprising:
providing a tangible object having a machine readable medium associated therewith;
inputting information related to the tangible object into the machine readable medium by altering the machine readable medium;
retrieving the information in the altered machine readable medium with a handheld device;
wherein the tangible object is a vehicle and the information inputted into the machine readable medium is maintenance information;
wherein when the information is retrieved from the machine readable medium a user is provided with information regarding maintenance of the vehicle.

6. The method of claim 5 wherein the tangible object is a vehicle and the information inputted into the machine readable medium is related to vehicle emissions.

7. (canceled)

8. (canceled)

9. The method of claim 1 wherein the machine readable medium is selected from the group consisting of radio frequency identification (RFID), bar code matrix, near field communication (NFC) and augmented reality.

10. The method of claim 1 wherein the handheld device is selected from a group consisting of cell phone, smartphone, and tablet computer.

11. The method of claim 1 wherein after the workout is completed, inputting information about the workout into the machine readable medium.
